(19) United States
(12) Patent Application Publication
(10) Pub. No.: US 2009/0247002 A1
(43) Pub. Date: Oct. 1, 2009

(54) Electrical socket with emergency lighting

(76) Inventors: Ching-Huei Wu, San Chung City (TW); Tai-Ho Huang, San Chung City (TW)

Correspondence Address: TROXELL LAW OFFICE PLLC, 5205 LEESBURG PIKE, SUITE 1404, FALLS CHURCH, VA, 22041, US

(21) Appl. No.: 12/078,510

(22) Filed: Apr. 1, 2008

(51) Int. Cl. H01R 3/00

(52) U.S. Cl. 439/490

(57) ABSTRACT

An electrical socket with emergency lighting is provided, including a casing, a circuit board, at least one light-emitting diode, at least two conductive terminals, and a power storage unit. The circuit board, the power storage unit, the at least one light-emitting diode, and the at least two conductive terminals are arranged inside the casing and are electrically connected to one another. The at least two conductive terminals are arranged in locations corresponding to at least two openings and at least two plug holes defined in the casing. As such, an electric socket with emergency lighting is provided.

### BACKGROUND OF THE INVENTION

1. Field of the Invention

The present invention relates to an electrical socket with an emergency lighting combined therein, which is formed by a combination of a casing, a circuit board, at least one light-emitting diode, at least two conductive terminals, and a power storage unit so that the electrical socket, although plugged in a wall outlet to serve as an emergency light at an emergency power failure situation, does not occupy the wall outlet for a corresponding socket is provided.

2. The Related Arts

Emergency lighting that is commonly available in the market is provided to mount to a wall surface or in a stairway exit. The emergency lighting device is provided with a storage battery, which is charged when power is normally supplied through for example an electrical main, and which discharge to power the emergency lighting when an emergency situation causing power failure occurs.

Since the emergency lighting is charged at a normal situation, the emergency lighting must be normally plugged to for example a wall outlet of the electrical main. This occupies one of the wall outlet available in a given space or room, causing inconvenience in operating other electrical appliance.

Thus, the present invention is aimed to provide an electrical socket serves as regular socket in a normal situation for the plugging of other electrical appliance and also functions as an emergency lighting in an emergency and/or power failure situation, so that the drawbacks of the conventional emergency lighting can be eliminated.

### SUMMARY OF THE INVENTION

An objective of the present invention is to provide an electrical socket that is combined with an emergency lighting, wherein the electrical socket comprises a casing in which a circuit board, a power storage unit, at least one light-emitting diode, and at least two conductive terminals are housed and are electrically connected to one another, and wherein the conductive terminals are arranged at locations corresponding to at least two openings and at least two plug holes defined in the casing to serve as a plug portion and a socket portion so that the electrical socket, which functions as an emergency lighting in an emergency, power failure situation, includes both an electrical plug and an electrical socket to eliminate the problem of wall outlet being occupied by the emergency lighting.

To achieve the above objectives, in accordance with the present invention, there is provided an electrical socket comprising a casing forming an interior space, the casing also forming at least two openings and at least two plug holes; a circuit board received in the interior space of the casing, the, casing being provided with at least one light-emitting diode that is in electrical connection with the circuit board; at least two conductive terminals received and fixed in the interior space of the casing and electrically connected to the circuit board, each of the conductive terminals having a first end forming a plug blade and a second end forming an electrical receptacle, the electrical receptacles being arranged at locations corresponding to the plug holes, the plug blades of the terminals being arranged at locations corresponding to the openings and extending out of the casing through the openings; and a power storage unit arranged in the interior space of the casing and electrically connected to the circuit board, the power storage unit being electrically connected to the terminals through the circuit board. With such an arrangement, an electrical socket with emergency lighting is provided.

### BRIEF DESCRIPTION OF THE DRAWINGS

The present invention will be apparent to those skilled in the art by reading the following description of preferred embodiments thereof with reference to the drawings, in which:

FIG. 1 is a perspective view of an electrical socket constructed in accordance with the present invention;

FIG. 2 is an exploded view of the electrical socket of the present invention;

FIG. 3 is a cross-sectional view of the electrical socket of the present invention; and

FIG. 4 is a perspective view illustrating an application of the electrical socket in accordance with the present invention.

### DETAILED DESCRIPTION OF THE PREFERRED EMBODIMENTS

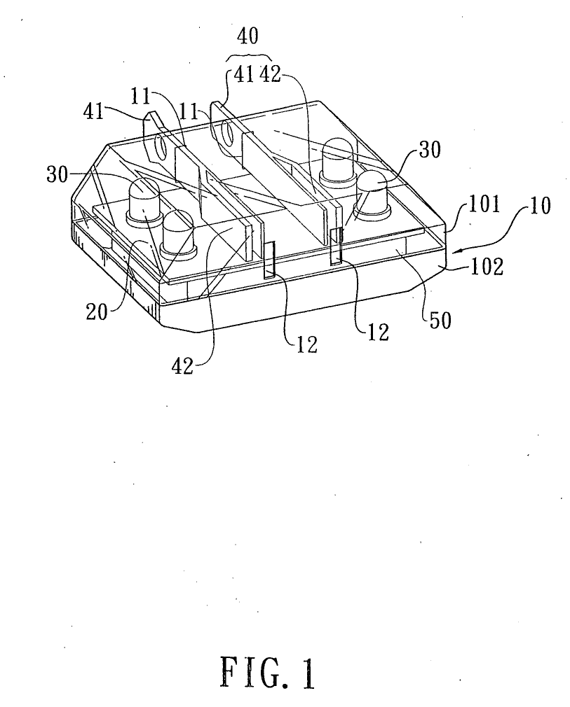

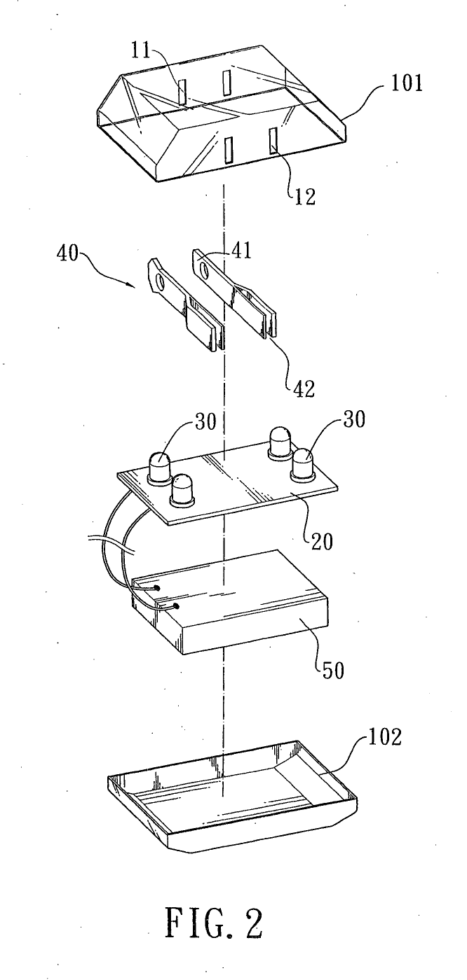

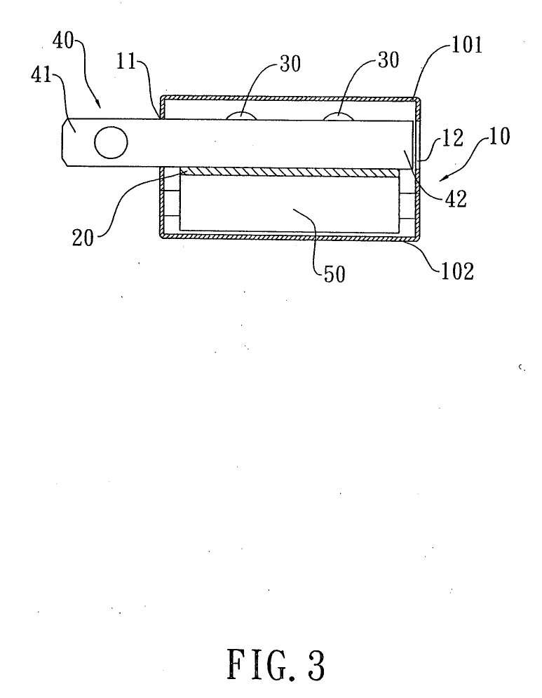

With reference to the drawings and in particular to FIGS. 1-3, an electrical socket constructed in accordance with the present invention is provided with emergency lighting means. The electrical socket comprises a casing 10, which forms therein an interior space. The casing 10 also forms at least two openings 11 and at least two plug holes 12. In the embodiment illustrated, the casing 10 is constituted by an upper casing member 101 and a lower casing member 102, which mate each other. In the embodiment illustrated, the two openings 11 and the two plug holes 12 are defined in the upper casing member 101. Further, in the present embodiment, the upper casing member 101 is light-transmitting; however, in other embodiments, the upper and lower casing members 101, 102 are both light-transmitting and/or the openings 11 and the plug holes 12 are defined in the lower casing member 102 or arranged between the upper and lower casing members 101, 102.

A circuit board 20 is fixed in the interior space of the casing 10. The circuit board 20 comprises at least one light-emitting diode 30 that is in electrical connection with the circuit board 20. The circuit board 20 is provided with a power supply circuit and a control circuit to effect control of power transformation, power accumulation, and power supply.

At least two conductive terminals 40 are arranged inside the casing 10 and each terminal 40 has an outer end projecting out of the casing 10 to serve as a plug blade 41 and an inner end forming a receptacle 42. The receptacles 42′ are set at locations corresponding to the plug holes 12 of the casing 10; and the plug blades 41 are set at locations corresponding to the openings 11 of the casing 10 and extend through the openings 11 of the casing 10, so as to respectively form a plug portion and a socket portion of the casing 10. In the embodiment illustrated, the two conductive terminals 40 are positioned on the circuit board 20 and are electrically connected to the circuit board 20. However, in other embodiments, the terminals 40 can be arranged at any desired locations in the interior space of the casing 10 and are put in electrical connection with the circuit board 20.

A power storage unit 50 is arranged in the interior space of the casing 10. In the embodiment illustrated, the power storage unit 50 is arranged below the circuit board 20 and is electrically connected to the circuit board 20. In operation, the power storage unit 50 can be arranged at any desired location in the interior space of the casing 10 and is put in electrical connection with the circuit board 20. The power storage unit 50 can be for example a rechargeable cell or a storage battery. The power storage unit 50 is electrically connected to the terminals 40 via the circuit board 20 to form a circuit loop.

The construction described above forms an electrical socket with emergency lighting in accordance with the present invention.

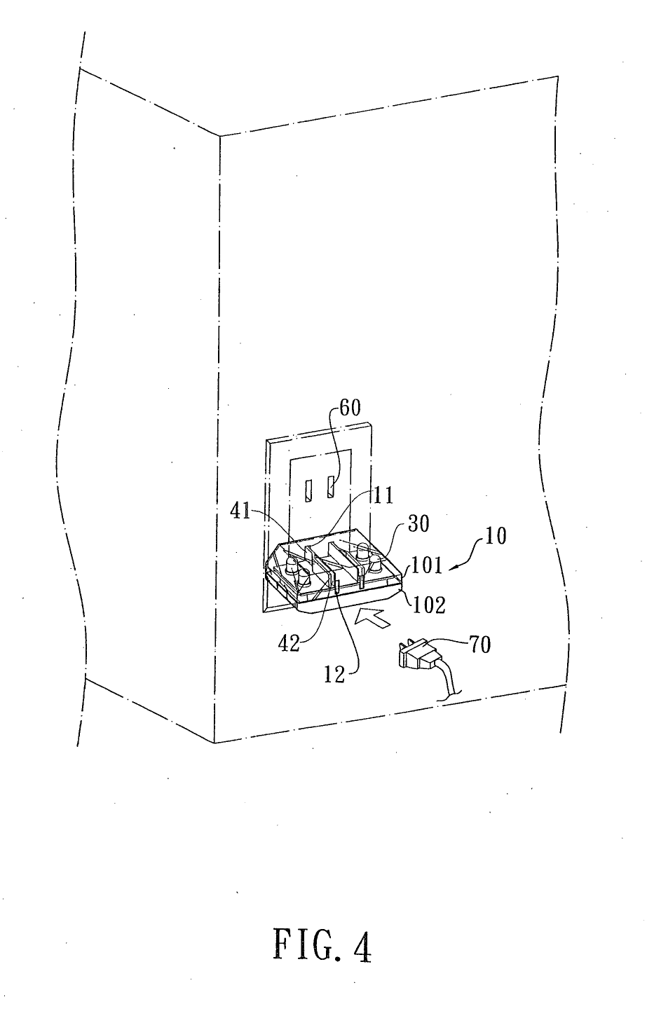

Referring to FIGS. 1-4, the electrical socket of the present invention features a combination of a casing 10, a circuit board 20, at least one light-emitting diode 30, at least two conductive terminals 40, and a power storage unit 50, wherein the power storage unit 50 is arranged inside the casing 10 and is in electric connection with the circuit board 20, as well as the at least one light-emitting diode 30 and the at least two conductive terminals 40; the at least two conductive terminals 40 have plug blades 41 extending out of the casing 10 through the openings 11 to form a plug portion of the casing 10 and the at least two conductive terminals 40 also have receptacles 42 arranged inside the casing 10 and corresponding to the plug holes 12 to form a socket portion of the casing 10. When the electrical socket of the present invention is plugged to for example a wall outlet 60 of electrical main via the plug blades 41 to form electrical connection with the electric main, in a normal situation where no emergency occurs, the power storage unit 50 receives electrical power from the wall outlet 60 and is thus charged and power is accumulated in the power storage unit 50. When power failure occurs due to any unexpected situation or emergency, the power accumulated in the power storage unit 50 is discharged to power the at least one light-emitting diode 30, whereby the at least one light-emitting diode 30 may serve as an emergency lighting. In this way, no additional emergency lighting facility and power sockets are needed. Referring particularly to FIG. 4, due to the design of combination of a socket portion and a plug potion in the electrical socket construction in accordance with the present invention, when power is normally supplied through the wall outlet 60 of the electrical main, the electrical socket of the present invention factually occupies no wall outlet, for a plug 70 of another electrical appliance can be connected to the receptacles 42 of the conductive terminals 40, which forms the socket portion of the casing 10, and with the plug blades 41 of the conductive terminals 40 are plugged into the wall outlet 60 of the electrical main, power can be supplied to the plug 70 of said another electrical appliance, and at the same time, the power storage unit 50 is also charged. If desired, any other adaptor can be put in combination with the electrical socket of the present invention to provide further convenience of use of electrical power.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electrical socket comprising:
a casing forming an interior space, the casing also forming at least two openings and at least two plug holes;
a circuit board received in the interior space of the casing, the casing being provided with at least one light-emitting diode that is in electrical connection with the circuit board;
at least two conductive terminals received and fixed in the interior space of the casing and electrically connected to the circuit board, each of the conductive terminals having a first end forming a plug blade and a second end forming an electrical receptacle, the electrical receptacles being arranged at locations corresponding to the plug holes, the plug blades of the terminals being arranged at locations corresponding to the openings and extending out of the casing through the openings; and
a power storage unit arranged in the interior space of the casing and electrically connected to the circuit board, the power storage unit being electrically connected to the terminals through the circuit board.

2. The electrical socket as claimed in claim 1, wherein the casing comprises an upper casing member and a lower casing member mating each other, and wherein the at least two openings and the at least two plug holes are defined in the upper casing member.

3. The electrical socket as claimed in claim 2, wherein the upper casing member is light-transmitting.

4. The electrical socket as claimed in claim 2, wherein the upper and lower casing members are light-transmitting.

5. The electrical socket as claimed in claim 1, wherein the power storage unit comprises a rechargeable cell.

6. The electrical socket as claimed in claim 1, wherein the power storage unit comprises a storage battery.
